(19) United States
(12) Patent Application Publication
(10) Pub. No.: US 2026/0370339 A1
(43) Pub. Date: Nov. 19, 2026

(54) SYSTEM AND METHOD FOR OPTICAL DATA TRANSMISSION USING SPIRAL-MODULATED LIGHT AND GEOMETRIC ENCODING PARAMETERS

(71) Applicant: Eliyah Omar El-Moreh, Kelowna (CA)

(72) Inventor: Eliyah Omar El-Moreh, Kelowna (CA)

(21) Appl. No.: 19/727,216

(22) Filed: Jul. 1, 2026

(30) Foreign Application Priority Data
May 15, 2025 (CA) 3273914

(51) Int. Cl. H04B 10/61

(52) U.S. Cl. CPC H04B 10/61

(57) ABSTRACT

An optical communication system and method encode data using a pitch-to-radius ratio κ of a spiral phase structure, defined as κ=h/r, where h is the pitch of a helical wavefront and r is the radius of the structure, together with a spiral coupling constant λ determined according to λ=κ²/(1+κ²). A transmitter generates a coherent optical signal, imparts the spiral phase structure using a spatial light modulator, spiral phase plate, or other diffractive or holographic optics, and encodes data by assigning it to a selected value of κ and a corresponding value of λ. The encoded signal is transmitted through a free-space path, optical fiber, or waveguide. A receiver detects the selected value of κ from the received signal, determines the corresponding value of λ, and recovers the data, improving precision over prior systems that detect only generic spiral or angular-phase characteristics.

### CROSS-REFERENCE TO RELATED APPLICATIONS

This application claims the benefit of foreign priority to Canadian Patent Application No. 3,273,914, filed May 15, 2025, the entire disclosure of which is incorporated herein by reference. This application is being filed more than twelve (12) months, but not more than fourteen (14) months, after the filing date of the above-identified Canadian application. Accordingly, this application is accompanied by a petition under 37 CFR 1.55(c) (Form PTO/SB/459) to restore the right of priority, together with the required petition fee and a statement that the delay in filing this application within the twelve-month period set forth in 37 CFR 1.55(b) was unintentional.

### FIELD OF THE INVENTION

The present invention relates to the field of optical data transmission and communication systems. More particularly, it pertains to systems and methods for encoding, transmitting, and decoding information using spiral-modulated light beams characterized by a pitch-to-radius ratio and a corresponding spiral coupling constant.

### BACKGROUND OF THE INVENTION

Modern communication systems increasingly rely on optical technologies to meet the growing demands of high-speed internet, data center throughput, and long-distance free-space optical links. Conventional optical systems encode information using amplitude, frequency (wavelength division), phase, and polarization. While effective, these encoding dimensions are inherently limited and are approaching theoretical capacity ceilings.

Research into the orbital angular momentum (OAM) of light has revealed that light beams with helical (spiral) phase fronts—characterized by a quantized topological charge [symbol] —can carry additional, orthogonal information channels. These modes are mutually independent and, in principle, can enable the transmission of multiple parallel data streams within a single optical medium.

However, existing OAM-based systems typically modulate only the topological charge [symbol] of the beam and detect only a generic spiral or angular-phase characteristic of the received signal, without deriving or utilizing a defined geometric relationship between the pitch and radius of the spiral phase structure. As a result, such systems are prone to mode crosstalk, instability over long distances, and sensitivity to alignment or environmental conditions, and do not provide a defined, calculable coupling parameter relating the geometric structure of the beam to the encoded data. These shortcomings restrict their scalability, reliability, and precision in real-world deployments.

### SUMMARY OF THE INVENTION

The present invention provides a system and method for optical data transmission in which information is encoded using a pitch-to-radius ratio κ of a spiral phase structure, defined as κ=h/r, wherein h is the pitch of a helical wavefront and r is the radius of the spiral phase structure, together with a spiral coupling constant λ derived from κ according to the relationship λ=κ²/(1+κ²).

The system includes a transmitter that generates spiral-modulated light using optical phase manipulation elements, such as spatial light modulators (SLMs), spiral phase plates (SPPs), holographic optics, diffractive optics, or integrated photonic circuits, and a modulation controller configured to determine λ according to that relationship and to map input data to a selected value of κ and a corresponding value of λ. The spiral-modulated light is transmitted through a free-space path, an optical fiber, or a waveguide that preserves the spiral characteristics.

A receiver is configured to receive the encoded optical signal from the optical transmission channel, detect the selected value of κ from the received encoded optical signal, determine the corresponding value of λ according to the same relationship, and recover the encoded data. This provides a defined, calculable geometric encoding parameter that is not merely a generic spiral or angular-phase measurement, improving precision and reliability relative to prior OAM-based systems.

### BRIEF DESCRIPTION OF THE DRAWINGS

FIG. 1 is a schematic diagram showing the main components of the spiral-based optical data transmission system, including a laser source (10), a spiral modulation unit (14), a modulation controller, a transmission channel interface (26), a spiral receiver unit (22), and a photodetector and signal processor (24). The diagram illustrates both logical signal flow and physical propagation.

### DETAILED DESCRIPTION OF THE INVENTION

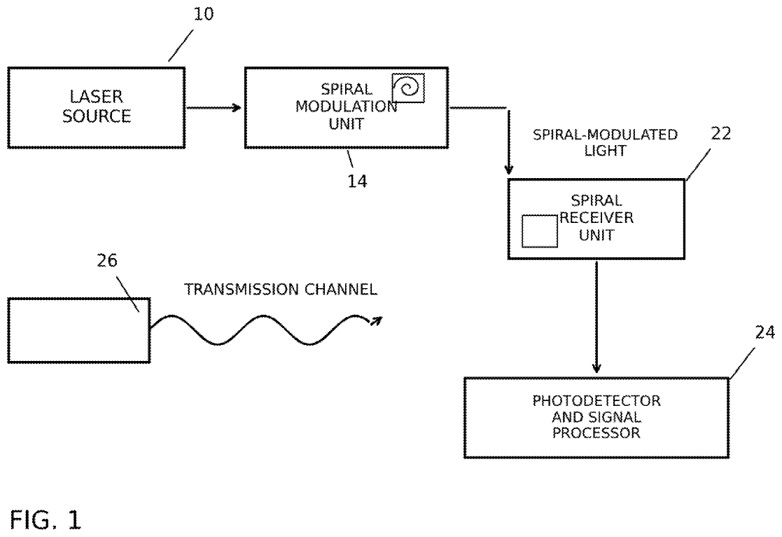

System Overview. The invention comprises the following main components, as illustrated in FIG. 1: a laser source (10), which is a continuous-wave or pulsed laser that provides a coherent optical beam for modulation; a spiral modulation unit (14), which is a system of optical components capable of imprinting a spiral phase pattern onto the laser beam, and which may include a spatial light modulator (SLM), a spiral phase plate (SPP), or other holographic or diffractive optics; a modulation controller, which is an electronic circuit or software-controlled device configured to determine a spiral coupling constant λ according to λ=κ²/(1+κ²) and to map digital input data to a selected value of the pitch-to-radius ratio κ and a corresponding value of λ, and to configure the spiral modulation unit accordingly; a transmission channel interface (26), coupling the spiral modulation unit to a transmission channel, being a medium such as free-space, fiber-optic cable, or waveguide capable of carrying spiral-modulated light while maintaining mode integrity; a spiral receiver unit (22), being an optical receiving system configured to detect the selected value of κ from the received optical signal, which may include a diffractive mode sorter, a spatial light modulator, or a photonic chip; and a photodetector and signal processor (24), being a device configured to convert the received optical signal into an electrical signal, determine the corresponding value of λ according to the same relationship, and decode the original data.

Modulation and Encoding Scheme. Data is encoded by assigning digital values (bits or symbols) to a selected value of the pitch-to-radius ratio κ of the spiral phase structure, defined as:

κ=h/r
wherein h is the pitch of the helical wavefront (axial distance per full rotation), and r is the radius of the spiral phase structure (transverse beam width). A corresponding spiral coupling constant λ is determined according to:

λ=κ²/(1+κ²)

By varying κ, and correspondingly λ, in response to digital input data, the system modulates the curvature and geometric structure of the transmitted optical signal. In some embodiments, encoding may further comprise assigning data to an orbital angular momentum (OAM) state, a pitch value, or a handedness (chirality) of the spiral beam, in combination with the selected value of κ and corresponding value of λ. These encoding dimensions may be used individually or in combination to represent binary digits or higher-order modulation symbols. The spiral modulation unit may be configured dynamically to produce the desired mode at each of a plurality of successive time intervals based on incoming data.

Multiple independent data streams may be transmitted simultaneously using orthogonal spiral states. Spiral encoding may be combined with conventional modulation formats such as amplitude modulation (AM), phase shift keying (PSK), or quadrature amplitude modulation (QAM) to increase symbol density. The modulation controller may update the spiral parameters in real time in response to varying data rates, channel conditions, or quality-of-service requirements.

Because spiral modes are substantially orthogonal under ideal conditions, they are naturally resistant to interference. However, to mitigate mode coupling or distortion, for example due to atmospheric or waveguide turbulence, the system may incorporate redundancy or error correction codes mapped to the spiral parameters. Symbol separation at the receiver may use diffractive elements or mode sorters to reduce crosstalk between spiral states.

Transmission Channel. The system transmits the spiral-modulated beam over a channel designed to preserve the geometric and curvature characteristics of the light. Depending on the application, the transmission channel may include free-space paths for line-of-sight communication, such as satellite, drone, or building-to-building links; specially designed optical fibers, such as ring-core, hollow-core, or photonic crystal fibers that support stable propagation of spiral modes; or curved or helical waveguides that match the geometric trajectory of the spiral beam to improve long-distance mode retention.

Spiral beams may be sensitive to environmental factors such as atmospheric turbulence, thermal drift, or mechanical misalignment. In some embodiments, the system incorporates adaptive optics or real-time beam correction to mitigate these effects during transmission. In fiber-based implementations, index engineering and precise geometry may be used to reduce modal dispersion and inter-mode crosstalk, so that spiral states remain distinguishable at the receiver. In hybrid configurations, the transmission channel may include both fiber and free-space segments, with intermediate optical interfaces used for spiral mode matching and continuity.

Receiver and Data Recovery. The receiver is configured to receive the encoded optical signal from the optical transmission channel and to detect, from the received encoded optical signal, the selected value of κ. The receiver, or an associated signal processor, is further configured to determine the corresponding value of λ according to λ=κ²/(1+κ²), and to recover the encoded data based on the detected value of κ and the determined value of λ. Recovering the data may comprise separating or identifying spiral characteristics of the received optical signal using a spatial light modulator, a diffractive optical element, a photonic chip, or one or more detectors.

Industrial Applications. The invention has broad applicability across sectors where high-capacity, secure, or specialized optical communication is desired, including high-speed data centers and optical interconnects; satellite and aerospace communication systems; long-range free-space optical communication, such as building-to-building or ground-to-air links; quantum communication using structured light, in which spiral modes may serve as high-dimensional quantum states; and secure communications, in which the difficulty of reproducing a precise spiral state without system knowledge may reduce susceptibility to eavesdropping, spoofing, or jamming.

Embodiments and Variations. While specific embodiments of the invention have been described, it will be understood that various modifications, substitutions, and variations may be made without departing from the scope of the invention. For example, different types of spiral modulation units, encoding algorithms, or transmission media may be used, provided that they preserve and utilize the pitch-to-radius ratio κ and spiral coupling constant λ as defined herein.

What is claimed is:

1. An optical communication method comprising:
generating a coherent optical signal;
imparting a spiral phase structure to the optical signal, the spiral phase structure having a pitch-to-radius ratio κ defined as:
κ=h/r
wherein h is a pitch of a helical wavefront of the optical signal and r is a radius of the spiral phase structure;
determining a spiral coupling constant λ according to:
λ=κ²/(1+κ²);
encoding data by assigning the data to at least one spiral characteristic of the optical signal, the at least one spiral characteristic comprising a selected value of κ and a corresponding value of λ;
transmitting the encoded optical signal through an optical transmission channel;
receiving the encoded optical signal; and
recovering the data from the received encoded optical signal by detecting, from the received encoded optical signal, the selected value of κ and determining the corresponding value of λ according to λ=κ²/(1+κ²).

2. The method of claim 1, wherein the at least one spiral characteristic further comprises an orbital angular momentum state.

3. The method of claim 1, wherein the spiral phase structure is imparted using a spatial light modulator, a spiral phase plate, holographic optics, diffractive optics, or an integrated photonic circuit.

4. The method of claim 1, wherein the optical transmission channel comprises a free-space optical path, an optical fiber, or a waveguide configured to preserve spiral characteristics of the optical signal.

5. The method of claim 1, wherein encoding the data comprises dynamically configuring the spiral phase structure at successive time intervals in response to input data.

6. The method of claim 1, wherein recovering the data comprises separating or identifying spiral characteristics of the received encoded optical signal using a spatial light modulator, a diffractive optical element, a photonic chip, or one or more detectors.

7. The method of claim 1, wherein the data is encoded using the selected value of κ and the corresponding value of λ in combination with amplitude modulation, phase shift keying, or quadrature amplitude modulation.

8. An optical communication system comprising:
a coherent optical source configured to generate an optical signal;
a spiral modulation unit configured to impart a spiral phase structure to the optical signal, the spiral phase structure having a pitch-to-radius ratio κ defined as:
κ=h/r
wherein h is a pitch of a helical wavefront of the optical signal and r is a radius of the spiral phase structure;
a modulation controller configured to determine a spiral coupling constant λ according to:
λ=κ²/(1+κ²),
wherein the modulation controller is further configured to map input data to at least one spiral characteristic of the optical signal, the at least one spiral characteristic comprising a selected value of κ and a corresponding value of λ;
an optical transmission channel configured to propagate the encoded optical signal; and
a receiver configured to receive the encoded optical signal from the optical transmission channel, detect, from the received encoded optical signal, the selected value of κ, determine the corresponding value of λ according to λ=κ²/(1+κ²), and recover the input data.

9. The system of claim 8, wherein the at least one spiral characteristic further comprises an orbital angular momentum state.

10. The system of claim 8, wherein the receiver comprises a spiral receiver unit and a photodetector and signal processor configured to convert received optical signals into electrical signals and decode the input data.

11. The method of claim 1, wherein the at least one spiral characteristic further comprises handedness of the spiral phase structure.

12. The system of claim 8, wherein the at least one spiral characteristic further comprises handedness of the spiral phase structure.

13. The method of claim 1, wherein the selected value of κ is selected from a plurality of discrete κ values corresponding to respective digital symbols.

14. The system of claim 8, wherein the modulation controller is configured to select the selected value of κ from a plurality of discrete κ values corresponding to respective digital symbols.

15. The method of claim 5, wherein the selected value of κ and the corresponding value of λ are varied at each of the successive time intervals to encode a sequence of digital symbols.

16. The system of claim 8, wherein the modulation controller is configured to vary the selected value of κ and the corresponding value of λ at successive symbol intervals to encode a sequence of digital symbols.

17. The method of claim 1, further comprising transmitting a plurality of independent data streams using a plurality of orthogonal spiral states.

18. The system of claim 8, wherein the spiral modulation unit is configured to generate a plurality of orthogonal spiral states for transmitting a plurality of independent data streams.

19. The method of claim 1, further comprising applying error correction or redundancy coding mapped to one or more spiral parameters of the optical signal.

20. The system of claim 8, wherein the modulation controller or signal processor is configured to apply error correction or redundancy coding mapped to one or more spiral parameters of the optical signal.
